(19) United States
(12) Patent Application Publication
(10) Pub. No.: US 2008/0307683 A1
(43) Pub. Date: Dec. 18, 2008

(54) Frame System for Sign Means Such as Posters

(75) Inventor: Egon Kjaer Jensen, Herning (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: EKJ HOLDING APS, Herning (DK)

(21) Appl. No.: 11/573,979

(22) PCT Filed: Aug. 17, 2004
(86) PCT No.: PCT/DK2004/000541

§ 371 Date: Aug. 20, 2008

(51) Int. Cl. G09F 15/00

(52) U.S. Cl. 40/606.17

(57) ABSTRACT

The present invention relates to a frame system (1) for sign means such as posters, and comprises a number of end profiles (2), a number of side profiles (3) and a number of stiffening girders (4), where said end profiles (2) and said side profiles (3) are adjoined at their respective end parts with a number of angel mountings (10), and said stiffening girders (4) are arranged between said side profiles (3), wherein said end and/or side profiles (2,3) are provided with a number of magnetic units (12), and said end and side profiles (2,3) are, furthermore, provided with a number of undercut recess (8,9) adapted to receive said angel mountings (10).

The present invention, furthermore, relates to a sign member for use in said frame system (1), and wherein said sign means are provided with a number of magnetic bands adapted to engage with said magnetic units (12) of said frame system (1).

### BACKGROUND OF THE INVENTION

1. Field of the Invention

The present invention relates to a frame system for sign means such as posters, and comprises a number of end profiles, a number of side profiles and a number of stiffening girders, where said end profiles and said side profiles are adjoined at their respective end parts with a number of angel mountings, and said stiffening girders are arranged between said side profiles.

The present invention, furthermore, relates to a sign member for use in said frame system.

2. Description of Related Art

Companies who promote themselves and their products e.g. at exhibitions or window displays and the like will likely wish to present themselves and their products in the best possible way.

They will, typically, use posters, pictures, lighting or other visual aids to do so. These visual aids must be suspended on the wall or a frame structure such that it is possible for people passing by to look at the presented materials, and quickly grasp the information and subsequently possibly take an interest in the company and its products.

The visual aids have been produced in different sizes and types, e.g. blinds in a frame structure, or cardboard posters mounted on the walls of the exhibition stand or on free-standing frame structures.

Cardboard posters or pictures on boards are, typically, mounted with mounting means such as screws, nails, Velcro tape or the like on the wall or on free-standing frame structures, which makes it tedious work to assemble or dismantle the company exhibition stand, because several mounting means are required when mounting or dismounting each cardboard poster or picture, which is time consuming.

The use of mounting means such as screws and nails can damage the cardboard posters or pictures on boards, especially with repeated mounting and dismounting, thus it can be necessary to produce new cardboard posters or pictures on boards on a regular basis.

Furthermore, visibly mounting means such as screws and nails can cover parts or disrupt parts of the poster or picture, with a consequent loss of the wanted visual effect of the poster and/or picture.

Achieving an optimal exhibition stand or window display is not always obtainable within the limits of the existing walls or space at hand, therefore it is necessary to build a new exhibition environment, where it is possible to present the right amount of posters or pictures at the right positions of the exhibition stand or window display for the maximum visual effect.

It is possible to build a new exhibition environment with existing frame systems, where it is possible to assemble several frames together, and then mount cardboard posters or pictures on boards on these frames.

The existing frame systems are, typically, assembled with assembly means such as bolts/nuts, screws or the like. Therefore, it is necessary to use an excessive amount of assembly means and tools in order to assemble the frame system, where after it is necessary to mount the cardboard posters or pictures on boards on these frames. Therefore, is it very time consuming to either erect or dismantle an optimal exhibition stand or window display.

### SUMMARY OF THE INVENTION

It is the object of the present invention to provide a frame system where it is possible to easily, and with very little effort, assemble or dismantle a frame system and to mount and/or dismantle a sign means on the frame system.

This can be achieved with a frame system according to the preamble of claim 1, and wherein said end and/or side profiles are provided with a number of magnetic units, and said end and side profiles are, furthermore, provided with a number of undercut recesses adapted to receive said angel mountings.

It is, furthermore, an object of the present invention to provide a sign means for use in said frame system.

This can be achieved with a sign means according to the preamble of claim 12, and wherein said sign means are provided with a number of magnetic bands adapted to engage with said magnetic units of said frame system.

### DESCRIPTION OF THE INVENTION

In a preferred embodiment of the present invention, the frame system comprises two end profiles, one positioned in the top and one in the bottom, two side profiles positioned opposite of each other, and adjoined with said end profiles at their respective end parts. Each end and side profiles are, furthermore, provided with a number of undercut recesses.

For a safe corner joint of said frame system, the corner joints between either a side profile and a top profile, or a side profile and a bottom profile, are provided with an angle mounting, where angle mountings of 90 degrees are used for the assembly of a rectangular frame system. In each corner joint, each leg of said angle mounting is received in said undercut recess of said profile, and fastened with a number of pointed screws, whereby a rigid frame system is obtained.

Said end profile comprises a base part and a top part, where said end profile can be produced as one unit.

To obtain a smooth transition from said side profile to said end profile, it is important that the cross-section forms of said top part and said side profile are equal, i.e. have the same amount of undercut recesses, e.g. for receiving a number of magnetic units or said angel mounting.

Said base part is a distance piece for raising the usable contact surface of said frame system from the floor, or to make space between said usable contact surface of said frame system and the ceiling. Hence, it is possible to provide said frame system with different types of said end profiles, where the height of said base part is different.

To be able to use both sides of said frame system, both said end profile and said side profile are symmetrical around an upright centre axis of said cross-section form of said profiles. Hence, there are undercut recesses on both sides of said profiles for the mounting of said angel mounting and said magnetic units.

If the height of said frame system is substantial, it could be necessary to support said poster a number of places along the length of the poster in order to obtain a presentable view of said poster. Therefore, said frame system furthermore comprises a number of stiffening girders, which are mounted between said side profiles either evenly or randomly. Said stiffening girders can be mounted in-between said side profiles in such position that two or more posters have sufficient support, and can be mounted on the same frame system.

The sign means can e.g. be posters made of paper, cardboard, plastic or textile, pictures on paper, cardboard, plastic or textile, and plates of wood, metal, cardboard, or the like.

To easily mount or dismantle a poster on the frame system, the end and/or side profiles are provided with a number of magnetic units, which are mounted on the frame system either evenly or randomly distributed around the frame system, where as it is possible to mount said sign means to said magnetic units. To mount said sign means to said magnetic units, said sign means are provided with a number of magnetic bands adapted to engage with said magnetic units of said frame system.

Said sign means have a number of magnetic bands or metallic bands attached on there backside, which either allow inaccuracy during the attachment of said magnetic bands or metallic bands, or allow said sign means to be moved slightly on said frame system when mounted thereon for adjustment of the actual position of the sign means. The magnetic bands or metallic bands are attached on the backside of the sign means with attachments means such as glue, double-acting tape, or be provided as an integrated part of said sign means. For the flexible types of sign means, e.g. posters of plastic, said magnetic bands or metallic bands used are so flexible that it is possible to roll said poster together into a roll.

To be able to connect two adjacent frame systems together for building the wanted exhibition environment, said side profiles are provided with at least one first locking unit. Said first locking unit comprises a protruding locking member adapted to engage in an opening in said side profile, where said opening is positioned around the outer sides of said side profile, whereby it is possible to connect two adjacent frame systems in a line. Alternatively, said protruding locking member is adapted to engage in said undercut recess of said profile when two of said frame systems are assembled in a 90 degree corner.

In a preferred embodiment of the present invention, said protruding element is provided with a head with a rectangular form, such that said protruding locking member can engage in said undercut recess or said opening of said profile, when the long side of said rectangular head is aligned with said opening or said recess, and said protruding locking member is brought into a locked position when said head is turned so said long side of said rectangular head is across said opening or said recess, whereby it is impossible to pull out said protruding locking member.

In stead of connecting two of said frame systems in a 90 degree corner, a special built corner profile is provided, which is a multi-unit built of two end profiles adjoined into a 90 degree corner, where it is possible to mount side profiles at the end parts of said two end profiles, and thereto connect an adjacent frame system. The same applies if it is necessary to connect three of said frame systems into a tee-cross, where an especially built tee-profile is provided with three ends part of said end profiles, whereon it is possible to mount side profiles, and connect an adjacent frame system thereto. And the same applies if it is necessary to connect four of said frame systems into a cross, where an especially built cross profile is provided with four ends part of said end profiles, whereon it is possible to mount side profiles and thereto connect an adjacent frame system.

To be able to produce said especially built tee-cross profile and cross profile it is necessary to connect one or two pieces of said end profiles to a trough-going piece of said end profile. To ensure that theses one or two pieces of said end profile are securely attached, said end profiles are provided with at least one second locking unit, and said end profiles are adjoined with a number of angel mountings, which are adapted to engage with said undercut recess of said end profile. To lock said end pieces together, said second locking unit comprises a protruding connection member adapted to engage with said angel mounting.

In a preferred embodiment of the present invention, said protruding connection member is engaging one leg of said angel mounting, by either pinching said angel mounting into said undercut recess, or catching a opening in said angel mounting. Meanwhile, the other leg of said angel mounting is received into a undercut recess of the perpendicular end profile, and fastened with a number of pointed screws.

To be able to easily assemble said profiles together into a number of frame systems constituting the exhibition environment, it is important that a minimum of tools are required, and that it is very simple to use present locking means. Therefore, each of said first and said second locking units are provided with a toggle handle, which is characterised by having a pivoting handle with two contact surfaces, where the distance from each contact surface to the centre of the pivotal movement of said toggle handle is different. Hence, said toggle handle is in an open position when the distance from a first contact surface to the centre of the pivotal movement is short, and said toggle handle is in a closed position when the distance from a second contact surface to the centre of the pivotal movement is large. Said toggle handle is ergonomically formed such that it is easy to move said toggle handle in a pivotal movement.

Said stiffener profiles are provided with at least one third locking unit, which allows said stiffener profiles to be mounted in between said side profiles, and maintained in any position. Said third locking unit comprises a displaceable locking member adapted to engage in a recess in said side profiles, where said displaceable locking member is mounted in said undercut recess of said stiffener profiles. In a preferred embodiment of the present invention, said displaceable locking member is spring loaded, hence the spring will ensure that a part of said displaceable locking member is projecting, and then being able to engage with said undercut recess of said side profile, thereby holding said stiffener profile in place. Said stiffener profile has preferably at least one of said displaceable locking member in each end parts.

The alternative to a spring loaded displaceable locking member is a displaceable locking member which is moved from a open position and fastened in a closed position for the mounting of said stiffener profiles between said side profiles, and the reverse motions apply when said displaceable locking member is moved from a closed position and fastened in a open position.

To be able to mount a sign means closely into the sides of said profiles, said magnetic units are exchangeably mounted in said undercut recess, thereby allowing a smooth surface of the side of said frame system. Said magnetic units are exchangeably mounted in said undercut recess, e.g. with self-tapping screws, and have a form which correlates to the width of said undercut recess. In a preferred embodiment of the pre-sent invention, said magnetic units are exchangeably mounted in enlarged openings of said undercut recess. To comply with said enlarged openings, said magnetic units have a form complementary to said enlarged openings, hence the contact surface between said magnetic units and said magnetic band on said sign means is larger, and the mounting of said sign means more secure.

Said angel mountings are mounted with attachment means into said undercut recesses, and said attachment means can be pointed screws, self-tapping screws or bolt/nut arrangements.

Alternatively, a frame system can comprise four or more side profiles or end profiles, which form a wall element or a ceiling frame, onto which a poster, a screen or fabric can be placed.

In a further alternative, the side profiles and two end profiles can be connected and used as e.g. an angle bracket for building constructions.

The advantages of using the present invention for providing a frame system are the obtaining of:
a frame system, which is easy to mount and dismantle, and is very versatile and flexible, because it can be connected in various ways, making it easy to build a optimal exhibition environment.
a frame system with a very rigid structure, due to use of angle mountings and undercut recesses and rigid materials, like aluminium, stainless steel and the like.
a frame system where it is possible to build in and hide wires or cables for lighting or displays, either inside the frame systems profiles, or between sign means positioned on opposite sides of the frame systems profiles.
a frame system which when stowed and ready to transport takes up very little space, because the frame systems either can be piled, and the sign means be stowed away inside the pile, or the frame systems can be dismantled into the basic parts. When the frame systems are piled e.g. on a pallet, they will function as a large trans-port box, keeping all parts of the frame systems together during transport and, furthermore, protecting the sign means from extensive damage. When the frame systems are dismantled into the basic parts of the frame system, they can be compactly packed, and because the frame system consist of a number of basic parts, which all can be used together, it is not necessary to pack the frame system's basic parts in a special order, which makes it very time efficient to dismantle and mount the frame system.

The invention is described in more detail below with reference to the accompanying drawings in which:

### BRIEF DESCRIPTION OF THE DRAWINGS

FIG. 1 shows a frame system according to the invention,

FIG. 2 shows an end profile according to the invention,

FIG. 3 shows an assembled end profile with two side profiles,

FIG. 4 shows a tee-cross profile according to the invention,

FIG. 5 shows one end of a stiffening girder according to the invention,

FIG. 6 shows the other end of the stiffening girder seen in FIG. 5,

FIG. 7 shows a corner profile according to the invention, and

FIG. 8 shows how a first locking unit according to the invention functions.

### DETAILED DESCRIPTION OF THE INVENTION

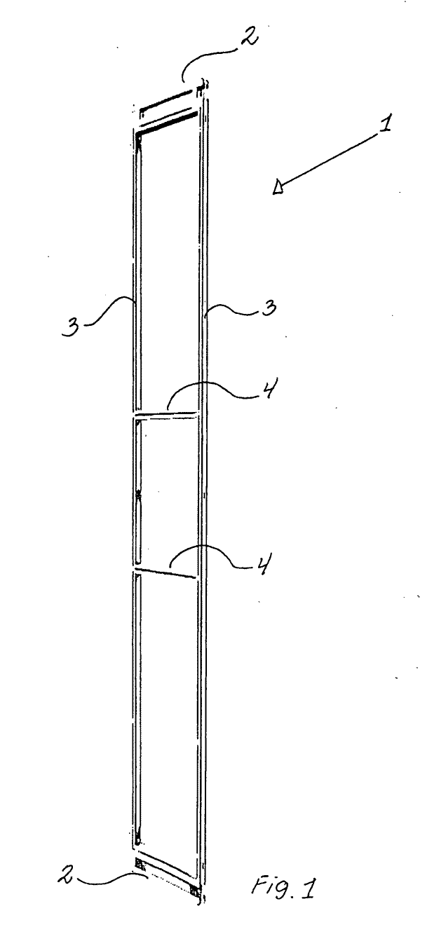

FIG. 1 shows a frame system 1 comprising two end profiles 2, one positioned in the top and one in the bottom, two side profiles 3 positioned opposite of each other, and adjoined with the end profiles 2 at their respective end parts. The stiffening girders 4 are arranged between said side profiles 3.

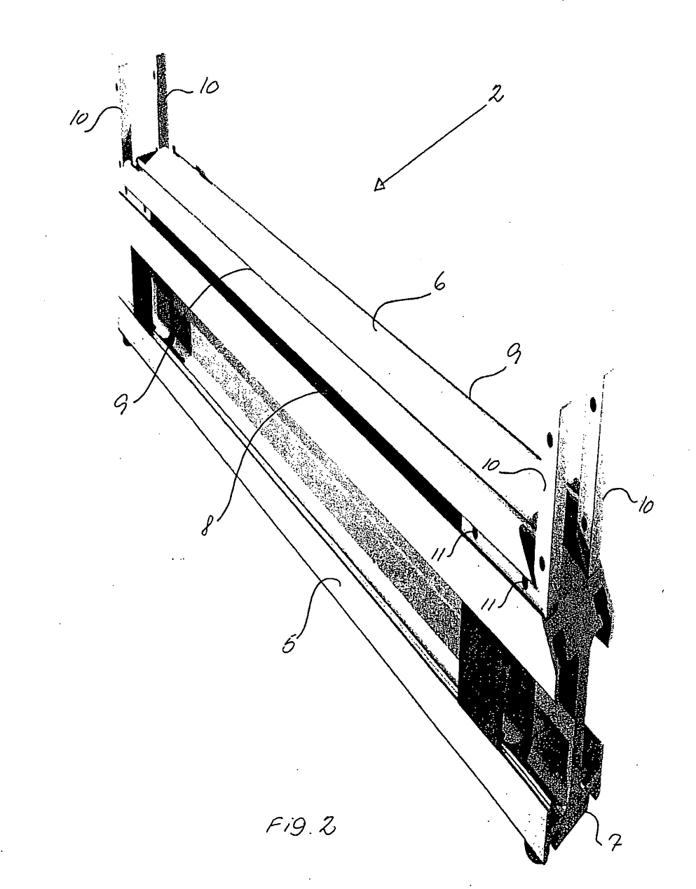

FIG. 2 shows an end profile 2 comprising a base part 5 and a top part 6, where said base part 5 is provided with a plate part 7, and said top part 6 is provided with undercut recesses 8,9. In undercut recess 8, angel mountings 10 are fitted, and fastened with e.g. pointed screws (not shown) through screw holes 11. The end profile 2 has the same form whether it is positioned at the top, or at the bottom of the frame system (not shown). Is the end profile 2A placed at the bottom of the frame system (not shown), the plate part 7 is placed on the floor surface (not shown). Is the end profile 2A placed at the top of the frame system (not shown), the plate part 7 is placed against the ceiling (not shown) or freely, and can then be used for positioning overhead girders (not shown), e.g. for lighting.

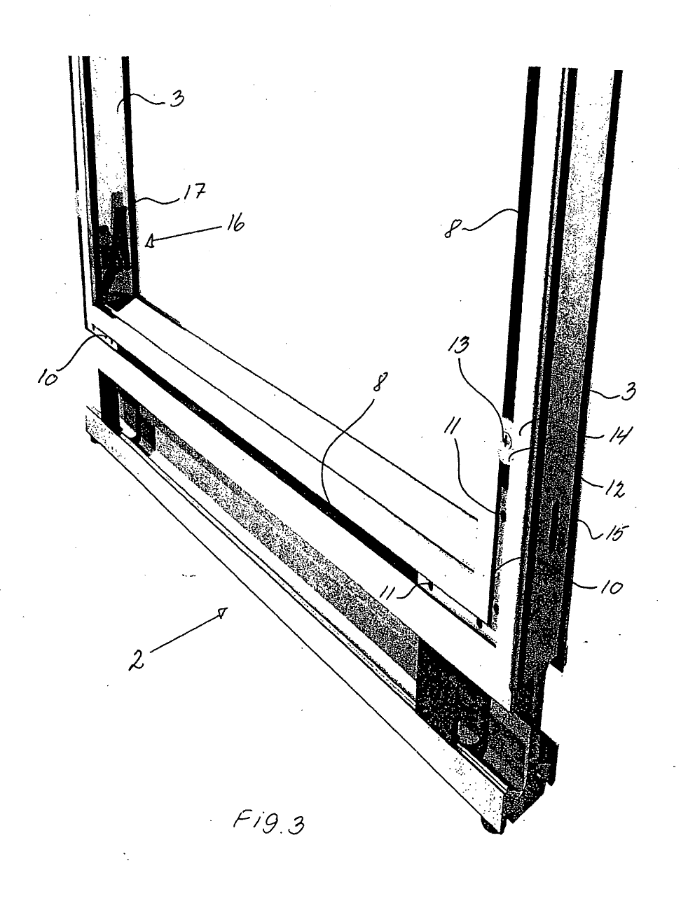

FIG. 3 shows an assembly of an end profile 2 with two side profiles 3, where the angel mounting 10 has one leg in the undercut recess 8 in the end profile 2, and the second leg in the undercut recess 8 in the side profile 3, and the angel mounting 10 is fastened in position with e.g. pointed screws (not shown) through screw holes 11. It is visible that the top part 6 of the end profile 2 has the same cross section as the side profile 3, hence a smooth corner joint is obtained. In the undercut recess 8 in the side profile 3, a magnetic unit 12 is mounted with a screw 13 in a enlarged opening 14, thereby providing a large contact surface for the magnetic band (not shown) attached on the back side of the sign means (not shown). At the far side profile 3, a first locking unit 16 is mounted, and it is possible to see the toggle handle 17 in a closed position. The first locking unit 16 is adapted to engage with the opening 15 in the side profile 3 of an adjacent frame system (not shown)

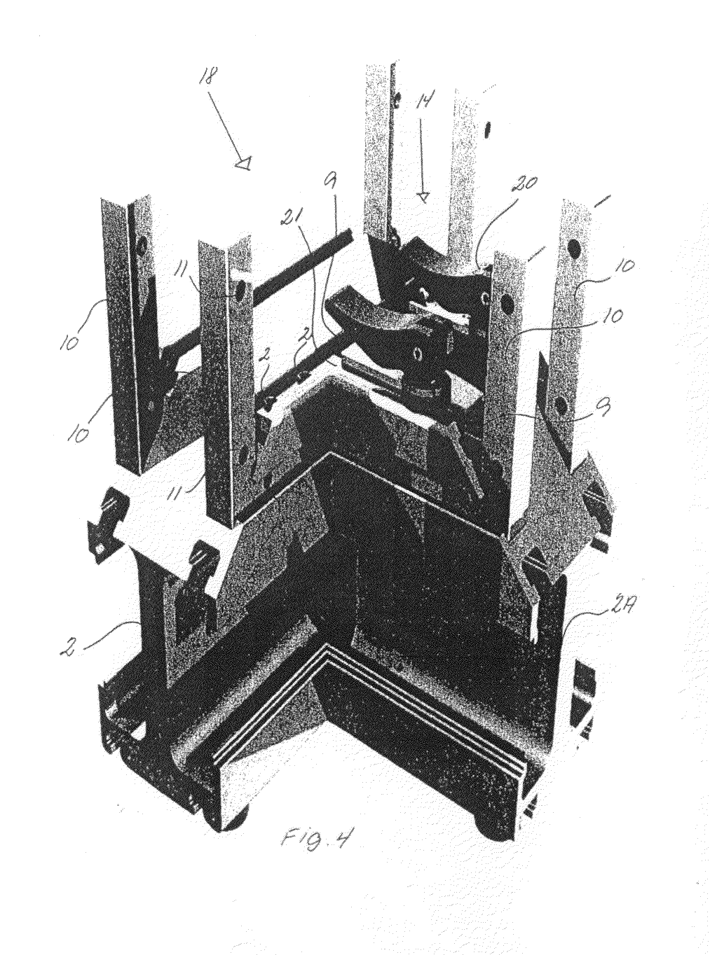

FIG. 4 shows a tee-cross profile 18, where an end profile 2 is connected with an end profile 2A. The tee-cross profile 18 is assembled with angel mounting 21, which has one leg in the undercut recess 9 in the end profile 2, and the second leg in the undercut recess 8 in the end profile 2A. The angel mounting 21 is fastened in the undercut recess 9 in the end profile 2 with pointed screws 22, and is fastened in the undercut recess 8 in the end profile 2A by the engagement of the second locking unit 19. The toggle handle 20 of the second locking unit 19 is shown in a locked position. The angel mountings 10 is positioned in the undercut recesses 8 of both the end profile 2 and end profile 2A and is fastened with e.g. pointed screws (not shown) through screw holes 11. The tee-cross profile 18 as shown is ready for the mounting of side profiles (not shown) onto the angel mountings 10.

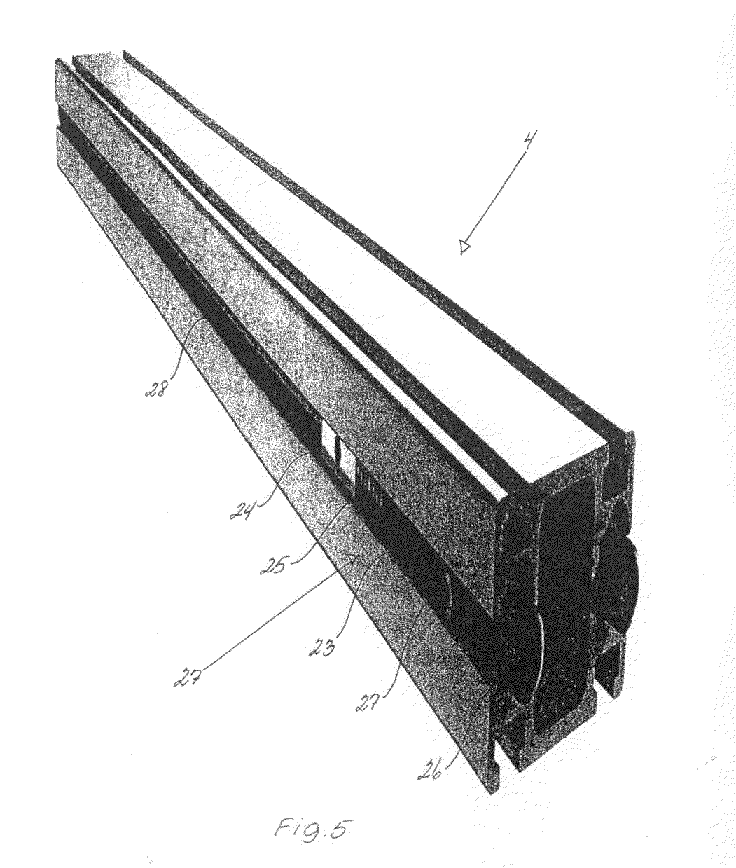

FIG. 5 shows a stiffening girder 4 provided with undercut recesses 28 positioned on opposite side of the stiffening girder 4. In the undercut recess 28, a third locking unit 22 is mounted comprising a displaceable locking member 23, a mounting plate 24 and a sprig 25, where the mounting plate 24 is fastened in a fixed position, and the displaceable locking member 23 is spring loaded, whereby a protruding part 26 of the displaceable locking member will be pushed out from the end of the stiffening girder 4. To displace the displaceable locking member 23, it is possible to use the knob 27 to slide the displaceable locking member 23 so that the spring 25 is compressed, and the protruding part 26 is positioned inside the undercut recess 28. Release of the activation of the knob 27 and the spring 25 will force the protruding part 26 out of the undercut recess 28 and into an enlarged opening (not shown) in the undercut recess (not shown) of the side profile (not shown). It is possible to have a third locking unit 22 in both undercut recesses 28 on opposite sides of the stiffening girder 4, and in each end parts of the stiffening girder 4.

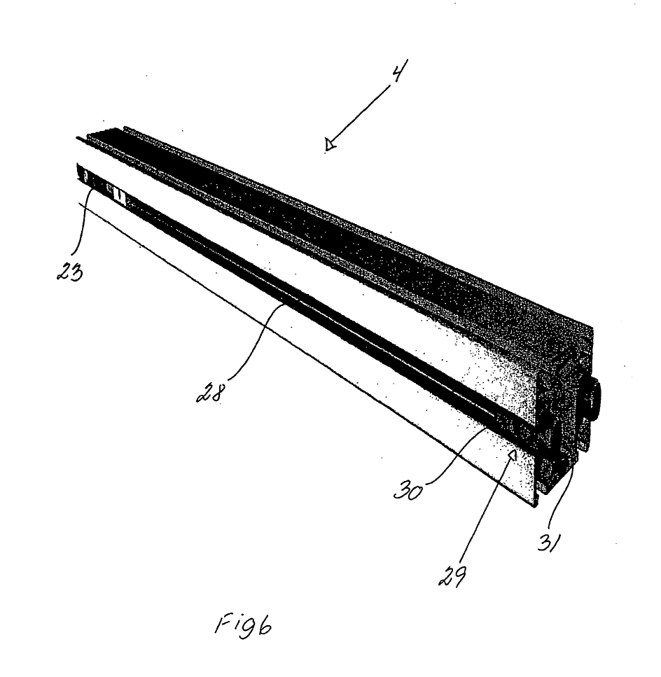

FIG. 6 shows stiffening girder 4, where a locking member 29 is mounted in the undercut recess 28, and fastened with e.g. a pointed screw (not shown) through screw hole 30. The locking member 29 is positioned such that the protruding part 31 of the locking member 29 is positioned outside the undercut recess 28, and then is able to engage with an enlarged opening (not shown) in the undercut recess (not shown) of the side profile (not shown). It is then possible to mount the stiffening girder 4 between two side profiles (not shown) by having the displaceable locking member 23 in one end, and the locking member 29 in the other end.

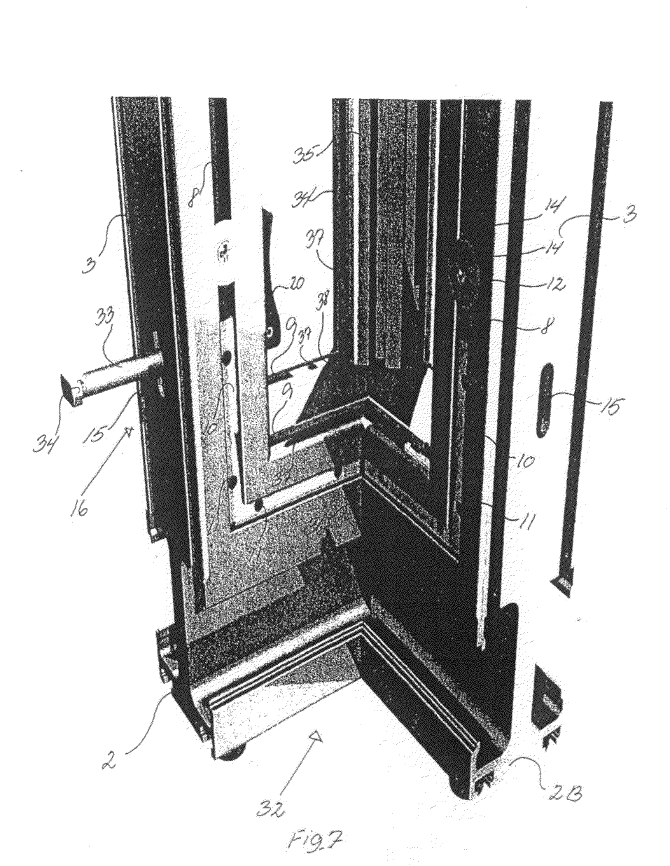

FIG. 7 shows a corner profile 32, where an end profile 2 is connected with am end profile 2B. The corner profile 32 is assembled with angel mounting 36, which has one leg in the undercut recess 9 in the end profile 2, and the second leg in the undercut recess 9 in the end profile 2A. The angel mounting 36 is fastened in the undercut recesses 9 with pointed screws 37. The angel mountings 10 is positioned in the undercut recesses 8 of both the end profile 2 and end profile 2B and is fastened with e.g. pointed screws (not shown) through screw holes 11, and side profile 3 is mounted thereon, where the angel mountings 10 is positioned in the undercut recesses 8 of side profiles 3, and is fastened with e.g. pointed screws (not shown) through screw holes 11. The special side profile 35 is mounted on the end profiles 2, 2B with angel mountings 38, which have a leg positioned in the undercut recess 9 in the end profiles 2, 2B and a leg in an undercut recess 39 of the special side profile 35, and fastened with pointed screws 37. A first locking unit 16 is positioned in the left side profile 3, and it is possible to see that it comprises a protruding locking member 33 extending through opening 15 in the side profile 3, and with a rectangular head 34, and a toggle handle 20 shown in a closed position, whereby the rectangular head 34 is positioned transversely of the opening 15 in the side profile 3, preventing it from being pulled out. The corner profile 32 is provided with magnetic unit 12 mounted with screws 13 in enlarged openings 14 in the undercut recess 9 of side profiles 3.

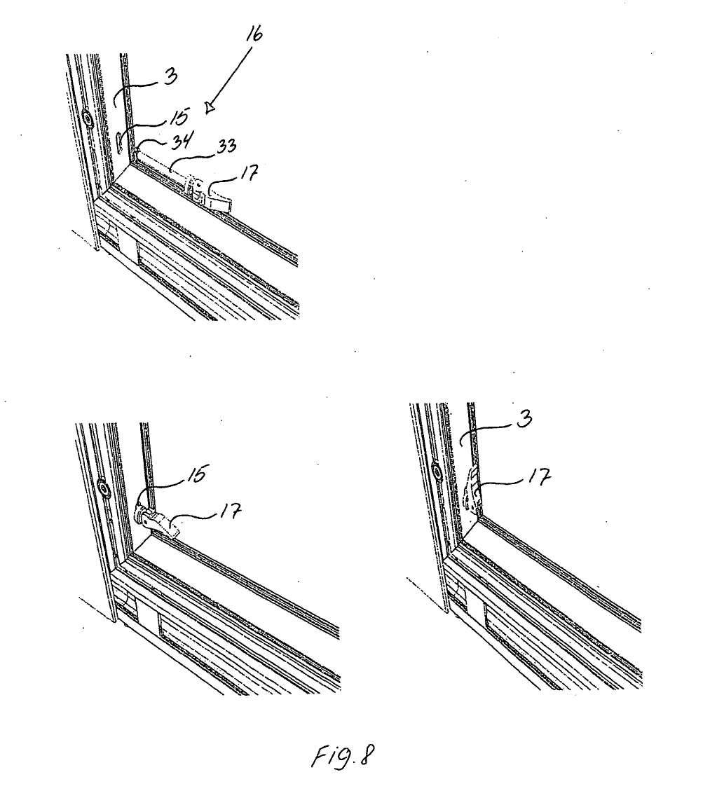

FIG. 8 shows how a first locking unit 16 functions, where
a protruding locking member 33 is lead into the opening 15 in the side profile 3, with the rectangular head 34 aligned with the opening 15, and the toggle handle 17 in a open position.
the protruding locking member 33 engages with an opening 15 of an adjacent side profile (not shown), and the first locking unit 16 is then rotated 90 degrees, so that the rectangular head 34 is positioned transversely of the opening 15 in the adjacent side profile (not shown), preventing it from disengagement.
the toggle handle 17 is pivoted into a closed position, whereby the adjacent side profile (not shown) and the side profile 3 is tightened up against each other in a very rigid frame structure.
the reverse motions are used if the frame systems it to be dismantled.

As shown in the FIGS. 1-8, the frame system 1 will be built up in the wanted structure, e.g. with electrical cables or other kinds of wires, before the sign means (not shown) are mounted on the frame system 1.

1-12. (canceled)

13. Frame system for sign means such as posters, and comprising a number of end profiles, a number of side profiles and a number of stiffening girders, where said end profiles and said side profiles are adjoined at their respective end parts with a number of angel mountings, and said stiffening girders are arranged between said side profiles, wherein said end and/or side profiles are provided with a number of magnetic units, and said end and side profiles are, furthermore, provided with a number of undercut recess adapted to receive said angel mountings.

14. Frame system according to claim 13, wherein said side profiles are provided with at least one first locking unit.

15. Frame system according to claim 14, wherein said first locking unit comprises a protruding locking member adapted to engage in an opening in said side profile.

16. Frame system according to claim 13, wherein said end profiles are provided with at least one second locking unit.

17. Frame system according to claim 16, wherein said end profiles are adjoined with a second end profile with a number of angel mountings.

18. Frame system according to claim 17, wherein said second locking unit comprises a protruding connection member adapted engage with said angel mounting.

19. Frame system according to claim 13, wherein each of said first and said second locking unit is provided with a toggle handle.

20. Frame system according to claim 13, wherein said stiffener profiles are provided with at least one third locking unit.

21. Frame system according to claim 20, wherein said third locking unit comprises a displaceable locking member adapted to engage in said undercut recess in said side profiles.

22. Frame system according to claim 13, wherein said magnetic units are exchangeably mounted in said undercut recess.

23. Frame system according to claim 13, wherein said angel mountings are mounted with attachment means into said recesses.

24. Sign members for use in said frame system according to claim 13, wherein said sign means are provided with a number of magnetic bands adapted to engage with said magnetic units of said frame system.
